(19) United States
(12) Patent Application Publication
(10) Pub. No.: US 2026/0320769 A1
(43) Pub. Date: Oct. 15, 2026

(54) INSPECTION DEVICE FOR A SURFACE COATING

(71) Applicant: ISRA VISION GmbH, Darmstadt (DE)

(72) Inventors: Jens HÜLSMANN; Mohamad AJAMI, Berlin (DE)

(21) Appl. No.: 19/481,081

(22) PCT Filed: May 3, 2024
(86) PCT No.: PCT/EP2024/062223

§ 371 Date: Nov. 3, 2025

(30) Foreign Application Priority Data
May 8, 2023 (DE) 10 2023 111 989.3

(51) Int. Cl. G06T 7/00; G06T 7/50; G06T 7/60; G06T 7/73

(52) U.S. Cl. CPC G06T 7/0004; G06T 7/50; G06T 7/60; G06T 7/73; G06T 7/97; G06T 2207/20081; G06T 2207/20084; G06T 2207/30156

(57) ABSTRACT

A method for inspecting a coating on a surface of an object to classify defects, which includes generating a plurality of first images of the object surface with respect to a first optical inspection channel, a plurality of second images of the object surface with respect to a second optical inspection channel. The plurality of images of each inspection channel is automatically analyzed with regard to the presence of a defect. If a defect is detected, for each inspection channel for which at least one image section can be assigned to the defect, and each detected defect by an NN algorithm, an inspection channel-specific defect type and an inspection channel-specific assessment parameter is determined, and subsequently a defect type is automatically selected from the inspection channel-specific defect types, which is output in relation to the detected defect at an interface of a data processing unit.

The present invention relates to a device for inspecting a coating on an object surface, for example a paint finish, and a corresponding method.

In automated manufacturing, for example in the automotive industry, high requirements are demanded of quality assurance. Particularly, when inspecting surface coatings of workpieces, for example paintwork, it is necessary to detect possible defects quickly and without great effort, to classify them, and to locate them. Various such devices and methods are already known and in practical use.

From document WO 2017/081029 A2 a method for the automated detection and robot-assisted processing of defects in a workpiece surface is known, in which an optical inspection of the surface is carried out to detect defects, then a three-dimensional measuring of the workpiece surface is performed using optical sensors in the area of detected defects, subsequently, a topography of the workpiece surface in the area of at least one defect is determined, a parameter set characterizing the at least one defect is then determined, the at least one defect is categorized on the basis of the determined parameter set, wherein the defect is assigned to a defect category, in the next step, a machining process is selected depending on the defect category of the at least one defect, including a machining path along which the defect is to be machined, and finally, a robot program for robot-assisted machining of the at least one defect is generated by computer. In the known method, the machining of the defects is adapted to the type of defect.

Document WO 2021/151412 A describes a device for the automatic detection of damage to vehicles, comprising a light tunnel, wherein the light tunnel has several light sources in the form of a strip, at least one camera, at least one first master camera, at least one second master camera and at least one local computer that comprises one or more powerful graphics processors, which receives and processes the images from the at least one camera, the first master camera and the second master camera, and calculates an output signal, wherein the output signal generates the class of the defect object and its coordinates in the image. Deep learning-based object detectors exist for detecting damage in the form of defect objects. This known device is comparatively complex in design.

Document WO 2022162417 A1 describes a method for detecting defects in color layers of objects using machine learning/artificial intelligence (AI) methods. Herein, a large number of patterns are projected onto the surface of the object and images of the surface with the patterns are generated. These images are then fed into a machine learning module to determine whether the object surface comprises defects. The images with color defects detected in this way are then displayed. With such a method, only very limited types of color defects may be detected.

In order to eliminate defects in a surface coating, it is necessary to know the type of defect in each case. If the type of defect is known and its location on the surface of the object is also known, then quick and easy further measures may be taken to remedy the defect in question.

The above object is solved by a method with the features of claim 1 and a device with the features of claim 7.

In particular, the above object is solved by a method for inspecting a coating on a surface of an object, wherein a plurality of first images of the object surface are generated with respect to a first optical inspection channel, a plurality of second images of the object surface are generated with respect to a second optical inspection channel, and, optionally, a plurality of another images of the object surface are generated with respect to at least one another optical inspection channel, wherein the plurality of images of each inspection channel is automatically analyzed with regard to the presence of a defect, wherein the following steps are performed for each inspection channel and each detected defect:
Assigning those image sections of the plurality of images of the respective inspection channel that contain the location of the respective detected defect,
Determining an inspection channel-specific defect type and an associated inspection channel-specific assessment parameter of the determined inspection channel-specific defect type for those inspection channels to which at least one image section of the location of the detected defect could be assigned, wherein the determination is made by means of a first NN algorithm trained for the respective inspection channel (i.e., an algorithm that includes an artificial neural network trained for the respective inspection channel) on the basis of the image sections of the respective inspection channel assigned to the respective defect,
   wherein subsequently, for each detected defect of the object surface, a defect type is selected by means of soft voting from the inspection channel-specific defect types of the respective inspection channels determined for the respective defect and the associated inspection channel-specific assessment parameters, wherein the defect type so selected for each detected defect of the object surface is output at an interface of a data processing device.

As explained above, there are at least two different optical inspection channels, but in many cases there are significantly more than two inspection channels (e.g., four to fifteen different inspection channels). A plurality of pictures (recordings) of the object surface is generated for each of these inspection channels. The images related to each optical inspection channel are generated by means of an illumination unit and an associated image recording unit, as well as an optionally provided data processing unit, if necessary. Each inspection channel is characterized by a predetermined inspection channel-specific illumination by the illumination unit, an inspection channel-specific recording by the image recording unit, and/or an inspection channel-specific processing of the captured data. Using the inspection channel-specific illumination, a large number of optionally digitized images (i.e., image data) of the light reflected from the coated object surface are generated by the image recording unit, which images contain a predetermined area of the object surface to be inspected (for example, a large number of recordings of a matrix camera). These recordings are transmitted to the data processing unit for further analysis, but may already be pre-processed in the image recording unit (e.g., digitized or processed with regard to image parameters such as brightness or contrast, or processed by subtracting a low-pass filtered recording from each recording). Depending on the respective inspection channel, the recording data transmitted by the image recording unit for one or more inspection channels are made available directly without being further processed by the data processing unit. The images of these inspection channels are therefore generated directly from the transmitted recording data (e.g., recordings of a matrix camera) corresponding to the image data. For example, the images of the first and second inspection channels may differ in that they were generated using different illumination patterns. Alternatively, the recording data are processed in the data processing unit in such a way that specified areas of the recording data are used for defect detection, for example, the areas along a stripe of a striped pattern or the areas between two stripes of a striped pattern. The recording data processed in this way are assigned to one inspection channel that focuses on the areas along the stripes and to another inspection channel that examines the areas between the stripes for possible defects. In a further alternative, the image data generated under different illumination conditions by means of the illumination unit are further processed on the basis of a calculation rule (see examples below) and made available as another inspection channel. This means that each inspection channel comprises an inspection channel-specific illumination and/or inspection channel-specific recording by the image recording unit and/or an inspection channel-specific processing of the recording data, i.e. each inspection channel differs from another inspection channel by at least one of these characteristic factors (illumination, recording, processing of the image data). Examples of this are shown below and may be based, for example, on the use of different illumination patterns, with regard to the characteristic factor ‘illumination’, for example, on the use of different cameras and/or different camera modes (e.g., recording data from different camera sections or camera pixel groups and/or recording data from different wavelength ranges and/or recording data from different time intervals (sequence) can be read out) with regard to the characteristic factor ‘recording’ and on the use of different calculation rules with regard to the characteristic factor ‘image data processing’ (e.g. for generating a sum image, contrast image, phase image or curvature image, subtraction of a low-pass filtered image). When comparing all characteristic factors, the characteristic factors ‘illumination’ and ‘processing of the image data’ are particularly noteworthy, as they are the easiest to vary.

The lighting unit is configured such that it illuminates the object in an area to be inspected with a predetermined inspection channel-specific illumination pattern. The illumination pattern may differ for different inspection channels, or recording data generated with different inspection channel-specific illumination patterns may be used for one inspection channel. The illumination pattern is either generated by the light-emitting part of the illumination unit itself or by shining light through a grid that generates the illumination pattern. The illumination is in the visible wavelength range. The illumination unit may be made in a single piece or from several elements spaced apart from each other.

The image recording unit, e.g., one or more cameras (e.g., matrix camera(s)), captures a plurality of recordings of the illuminated area of the object surface, i.e., it generates an image recording sequence of the recordings of the illumination pattern, which the image recording unit sees in reflection (incident light arrangement) in relation to the object. In this case, the image recording unit and the object may perform a relative movement with respect to each other so that the entire surface area of the object to be inspected can be captured by the image recording unit. Accordingly, the illumination unit may also perform a relative movement with respect to the object, e.g., together with the image recording unit. The digitized recording data generated by the image recording unit are transmitted by the image recording unit to the data processing unit (computer, processor, or the like) and made available for this purpose at a corresponding interface of the image recording unit connected to the data processing unit.

The image recording unit may be composed of one or more matrix cameras. The matrix camera is also referred to as area camera and records a larger area of the object. It may be designed as a CCD camera, for example. The matrix camera captures from the illuminated area the light intensity by a large number of pixels, which are arranged in rows and columns, i.e., in a matrix. For this purpose, the matrix camera comprises a light-sensitive element (e.g., a CCD sensor) for each pixel. The size of the area captured by each light-sensitive element (pixel) determines the resolution of the matrix camera. For example, several matrix cameras may be arranged adjacently in a direction transverse to a relative movement of the image recording unit and the object to inspect a particularly wide object.

As explained above, the object and the image recording unit (and, optionally, the illumination unit) may perform a relative movement at a predetermined movement speed in a feed direction relative to each other. The transverse direction runs transversely, preferably perpendicular to the feed direction. For example, the object is passed by the image recording unit (and, optionally, the illumination unit) at a predetermined speed on a corresponding belt or as web material, and the image recording unit (and, optionally, the illumination unit) does not move. Alternatively, only the image recording unit (and optionally the illumination unit) moves, or both the image recording unit (and optionally the illumination unit) and the object move simultaneously. It is advantageous for the processing of the image capture data if the relative movement of the object and the image recording unit (and, optionally, also the illumination unit) is a uniform movement, i.e., a movement at a constant speed. This simplifies the processing of the image capture data for the inspection of the object.

The illumination unit or each element of the illumination unit may comprise several individually switchable illumination elements, for example light-emitting diodes (LEDs) or groups of jointly switchable light-emitting diodes (LEDs). In this case, the illumination pattern is generated by the entirety of the illumination elements themselves. An individually switchable illumination element may therefore consist of a single illumination device, e.g., an LED, or several illumination devices grouped together and switchable together, e.g., a group of several LEDs. In one embodiment, the data processing unit may be configured to control the individual lighting elements individually, i.e., to switch them on and off. For example, bright fields/stripes are realized by switched-on LEDs and dark fields/stripes by switched-off LEDs. This allows flexible inspection channel-specific illumination configurations to be achieved with different patterns and/or with light of different wavelengths.

Alternatively or additionally, the illumination unit may comprise a lighting device (e.g., one or more fluorescent tubes) that completely illuminates the area to be illuminated. In this case, a grid is arranged between the lighting device and the object, which produces the desired illumination pattern. The bright fields/lines are created by corresponding slits in the grid and the dark fields/lines by corresponding bars.

The illumination unit may provide illumination patterns that realize bright field illumination and/or dark field illumination. The illumination device may alternatively or additionally emit light of different wavelengths.

Since dark field illumination does not occur immediately at the transition from an illuminated to a non-illuminated lighting element, it may be advantageous in one embodiment of an illumination pattern to combine several switched-off, i.e., dark lighting elements adjacently. In another embodiment, an optical light shaping unit may be arranged between the illumination unit and the object and/or between the object and the image recording unit. The light shaping unit may in particular be composed of lenses, diffusers, and/or microlenses.

The illumination pattern may, for example, be a striped pattern of light (illuminated) and dark (non-illuminated) stripes, which runs in the feed direction explained below or transversely to this feed direction. The striped pattern may have the same shape for different inspection channels (e.g., same stripe shape, same stripe widths, same stripe direction) but may be formed so as to be offset from each other. The striped patterns of different inspection channels may also differ in terms of stripe width or the signal shape of the stripes in the transverse direction to the stripes (e.g., rectangular shape, sinusoidal shape). In addition, an inspection channel may comprise a pattern representing full illumination (i.e., all illumination elements are illuminated).

The inspection method can be implemented as a computer-implemented method, i.e., a method performed with a data processing unit (computer), based on the data from the image captures of the inspection of the object. The method may also include controlling the illumination unit and the image recording unit in such a way that images for the first inspection channel, the second inspection channel, and, optionally, the another inspection channel are generated for all sections of the area to be inspected, for example, sequentially and/or simultaneously. For example, on the basis of the image captures, the defects are determined using defect detection methods as local deviations from an image capture signal that would be produced by a defect-free object. In the context of the present invention, recordings, recording data, or images and image data are understood to be data, that assign an intensity value (e.g., between 0 and 255) to each point of a given two-dimensional matrix (image). This may be a pixel image or a vector graphic.

The illumination unit and the image recording unit are optionally electrically connected to each other via a control unit so that the illumination of the object and the capture of recordings of the object surface may be controlled. The data processing unit may also be connected to the illumination unit and the image recording unit and form the control unit. Alternatively, the data processing unit may be located remotely from the illumination unit and the image recording unit, wherein particularly the use of a remote server or cloud computing is included.

According to the method of the invention, after the images have been generated, they are analyzed for the presence of defects on/in the surface coating of the object. Herein, at this is point in time, the type of defect is not relevant. It is merely determined that there is a deviation in the surface of the object from the desired surface condition that is generally considered to be a defect, and the location of the respective defect is determined. The method according to the invention subsequently performs a more detailed analysis of the detected defect in terms of the defect type, as explained below. For example, the following defect types may be distinguished: inclusions, craters (dents), protrusions (bumps), contamination (dust), pseudo-edges, orange peel, pores, cracking, grinding marks, specks, surface defects, blistering, scratches, and wet marks. A pseudo-edge is a type of defect that occurs when the edge of a chassis is captured. The presence of defects on/in the surface coating of the object is determined using image processing methods. In an embodiment, the detection of a defect in the images of the respective inspection channel is performed depending on the respective inspection channel. In an embodiment, a low-pass filtered image and/or a gradient image is used for defect detection. For example, for a proportion of the inspection channels, the respective low-pass filtered image is subtracted from each image and then examined to determine whether the gradients of adjacent image points present in the image exceed or fall below a predetermined first threshold value, or whether the absolute values of the image points (pixels) exceed or fall below a predetermined second threshold value. Herein, the respective threshold value may be set individually for specified areas of the image (so-called tiles). At points where the first or second threshold value is exceeded or not reached, the presence of a defect is assumed. As another criterion, the criterion of the size of the deviation may be used in another embodiment. This means, for example, that a defect is only recognized as such if the area of the image in which the threshold value is exceeded or not reached consists of a predetermined number of pixels (for example, at least 5 pixels). This prevents artifacts from image processing from being recognized as defects. In another embodiment, before examining whether a gradient or absolute value present in the image exceeds or falls below a first or a second threshold value, a mask (overlay) is applied to the image (i.e., added or subtracted or as a partial replacement of the measured recording data). This overlay may be calculated based on the image data or preset based on the location of the captured object surface. This application is used in particular when a preset illumination pattern is used for an inspection channel or when an object edge is located in the area of the image.

If the presence of a defect is detected (and also its position/location, e.g., in relation to the object), then for each existing inspection channel (i.e., the first inspection channel, the second inspection channel, and each another inspection channel), those image sections are determined that contain the location of the respective detected defect. In one embodiment, several image sections per inspection channel may be assigned to the location of the detected defect, since several image sections are generated for each inspection channel from each section of the surface of the object to be inspected, for example, in such a way that the image recording unit comprises several cameras, each of which is directed at the same section and captures it from different directions, or in such a way that the same section is captured multiple times during the relative movement of the object and the respective image recording unit. Herein, an image section is subarea/section/portion of an image (a picture) of the respective inspection channel, wherein the location of the defect is arranged approximately in the center with respect to the image section and wherein, under certain circumstances, the image section may also comprise the entire image. The image section is arranged in another embodiment in such a way that it has the same predetermined size (number of pixels or size of the pixel matrix in both directions) for all inspection channels (e.g., 80 pixels×80 pixels). The location of the defect in the respective image may be determined based on the known relative movement of the object and of the respective image recording unit of the respective inspection channel. Accordingly, the image section assigned to the respective defect may be determined on the basis of the specified size of the image section.

Subsequently, for each inspection channel and each detected defect, an inspection channel-specific defect type and an associated inspection channel-specific assessment parameter of the determined inspection channel-specific defect type is determined for each inspection channel and each detected defect by means of a first NN algorithm trained for the respective inspection channel on the basis of the image sections of the respective inspection channel assigned to the respective defect, wherein one or more image sections may be assigned to the respective inspection channel.

The used first NN algorithm represents an assignment based on a neural network. The first NN algorithm uses the neural network to assign to the image sections of an inspection channel an inspection channel-specific defect type and an associated inspection channel-specific assessment parameter for this defect type, for example a confidence variable resulting from the NN algorithm. The assessment or confidence variable indicates the probability for the respective defect type that this defect type is present and is derived from the previous training of the NN algorithm. The assessment parameter can, for example, have a value that is greater than zero but less than or equal to 1. In addition, defect types that may not be determined with the respective inspection channel may be assigned an assessment parameter of zero. In one embodiment, the neural network represents a convolutional neural network (CNN) with a known structure, through which the above-mentioned assignment is made. A CNN is an NN algorithm that is particularly suitable for image processing problems. In another embodiment, a residual neural network (ResNet) with a known structure is used as the NN algorithm, in which the feature vector (inspection channel-specific defect type and associated inspection channel-specific assessment parameter) is to some extent “amplified” in the form of feedback. The ResNet has a large number of layers, through which so-called “skip connections” or “shortcuts” are created during training (e.g., double or triple layer skip connections), which skip layers if they do not improve the algorithm (model). This accelerates training and also speeds up the assignment when using the trained algorithm. In one embodiment, a ResNet with at least 18 layers is used. For example, a ResNet18 consisting of 18 layers and using a residual block architecture is used as the NN algorithm. Residual blocks enable deep networks to be trained by adding a “shortcut” or “skip connection” that allows the network to send information back from previous layers during training. This prevents the problem of “gradient vanishing” that occurs in deep networks. The ResNet18 model is trained in an embodiment using the Adam optimizer and the Negative Log Likelihood Loss function. The Adam optimizer is an adaptive learning rate optimizer that calculates an adaptive learning rate for each parameter of the model and updates the parameters accordingly. This optimizer allows the model to converge quickly and improve accuracy. The Negative Log Likelihood Loss function is well suited for the present classification task. The function measures the error between the model's prediction of the defect and the actual defect type. The greater the error, the higher the loss value. The goal of training is to minimize the loss value by adjusting the model's parameters. In addition, a “Stepwise Learning Policy” method is used in an embodiment to adjust the learning rate during training. With the Stepwise Learning Policy, the learning rate is reduced to a certain number of epochs in order to improve the model's learning behavior and increase the convergence speed. The initial learning rate, step size, and learning rate schedule are determined for the present task (defect classification with specific defect types) based on previous experimental evaluations.

If an inspection channel-specific defect type and a corresponding assessment parameter have been determined for the respective defect for all or a proportion of the inspection channels (depending on whether at least one image section of the location of the respective defect may be assigned to this inspection channel for the respective inspection channel), a defect type is subsequently selected for this detected defect of the object surface by means of soft voting from the inspection channel-specific defect types determined for the respective defect of the respective inspection channels and the respective associated inspection channel-specific assessment parameters. Soft voting is characterized by the fact that the assessment parameter (confidence) is taken into account when selecting the most probable defect type. In soft voting, for example, the frequency and an average value (e.g., the arithmetic mean) of the respective assessment parameters determined for each defect type are calculated for respective defect type of all inspection channel-specific defect types determined. In each case, with reference to the number of inspection channels examined, the frequency of the respective defect type is then multiplied by its average assessment parameter (also based on the number of inspection channels) to calculate a product. The defect type with the largest product is selected as the defect type. The defect type selected in this way is the one that is most likely to be present in the defect based on the results from the individual channels. If the product of two defect types is the same, the defect type that was determined more frequently (more often) is selected. If the frequency is also the same, both defect types may be specified as the result, for example.

The defect type determined for each defect on the object surface is then output at an interface of a data processing unit.

The method according to the invention provides a simple, fast, and cost-effective inspection of coated object surfaces, which is also characterized by very good results.

The first NN algorithm is trained as described in detail below. It may thus be adapted to the specific inspection task/object to be inspected, because data specific to the respective object/inspection task may be used for training. This ensures a high degree of accuracy during inspection.

Based on the defect types output at the interface of the data processing unit (e.g., as a list of all defects with the corresponding defect type for the respective object), an automatic assessment of the quality of the object or the surface coating of the object may be made. The data may also be output on a corresponding display device so that a quality assurance employee can visually assess it. Based on this data provided at the interface, the object may also be automatically removed from the production process if, based on this data, the object does not meet the quality requirements.

This can be the case, for example, if the number of defects of one or more specific defect types is exceeded.

In one embodiment, the location (position) of each detected defect on the object surface in a predefined coordinate system is also determined. This may be done, for example, by means of coordinate transformation based on a CAD model of the object, calibration of the image recording unit and/or, optionally, the speed of the relative movement of the object and the image recording unit or the respective positions. The predefined coordinate system may, for example, represent the coordinate system of the object. In this way, and optionally by means of comparison with the CAD model of the object, the defect can then be located very precisely on the object surface. Based on this information, a marking device downstream of the inspection device may, for example, mark the defect by applying (e.g., spraying) a water-soluble paint around it on the surface of the object. Alternatively or additionally, knowing the location of the defect may facilitate the control of a device for removing the defect.

In one embodiment, the image sections of an inspection channel are generated on the basis of a plurality of recordings of different sections of the object surface when the object surface is illuminated with a predetermined, inspection channel-specific pattern. The images of the respective inspection channel are generated directly from the recordings of the object surface transmitted by the image recording unit, which may be preprocessed, wherein all recordings of an inspection channel are generated when illuminated with the same predetermined pattern. Different images may contain different sections of the object surface, for example due to relative movement of the object and the image recording unit. Optionally, the recordings are processed by the image recording unit and/or data processing unit, for example, digitization, contrast modification, and/or preprocessing is performed, or image data generated by low-pass filtering of the respective recording is subtracted from each recording.

Images of an inspection channel are generated from transmitted recording data, wherein for further analysis with regard to defects, either only the areas on stripes or only areas of the transition zone between two adjacently located stripes are used. Despite identical illumination and recording conditions, the corresponding images are assigned to two different inspection channels, since the image data is processed differently.

In one embodiment, the images of an inspection channel are generated on the basis of a first plurality of recordings of different sections of the object surface when the object surface is illuminated with a first predetermined pattern and of at least a second plurality of recordings of different sections of the object surface when the object surface is illuminated with at least a second predetermined pattern, as well as of the pixel-wise calculation of a sum image, a contrast image or a phase image from the recordings of the section at the same location.

For example, recordings of the object surface are generated using two or four different patterns, wherein each pattern comprises sinusoidal striped intensity distributions. The two patterns are shifted by half a sine period and the four patterns by a quarter sine period, for example. The intensities of the pixels of the recordings for the two patterns are designated I_{A} and I_{B}, while the intensities of the pixels of the recordings for the four patterns are designated I₁, I₂, I₃, and I₄. Using the following calculation rules, a sum, contrast, or phase image is generated, wherein each pixel of the sum image (I₀), contrast image (K), phase image (I_{φ}), or curvature image (C) is calculated pixel by pixel from the recordings taken at the same location as follows:

$${I}_{0} = \frac{{I}_{1} + {I}_{3}}{2} = \frac{{I}_{2} + {I}_{4}}{2} = \frac{{I}_{A} + {I}_{B}}{2} \qquad ( 1 )$$

$$K = \frac{\sqrt{{( {I}_{1} - {I}_{3} )}^{2} + {( {I}_{2} - {I}_{4} )}^{2}}}{{I}_{1} + {I}_{3}} \qquad ( 2 )$$

$$ϕ = {tan}^{- 1} \frac{{I}_{2} - {I}_{4}}{{I}_{1} - {I}_{3}} \qquad ( 3 )$$

A curvature image (C) may be calculated from the phase image by making the phase image steady and calculating a mathematical derivative perpendicular to the direction of the stripes of the used illumination pattern (transferred to the recordings and the resulting image, respectively). The plurality of calculated sum, contrast, phase, or curvature images for an object each represent an inspection channel (i.e., the inspection channel of the sum images, the inspection channel of the contrast images, et cetera). The images of these inspection channels may also be used in a manner analogous to the inspection channel images described above to respectively determine an inspection channel-specific defect type and an associated inspection channel-specific assessment parameter by means of a correspondingly trained first NN algorithm.

In one embodiment, by means of a second NN algorithm, a binary defect representation is determined for a specific defect from the image sections assigned to the respective defect of at least one specified inspection channel of the first inspection channel, the second inspection channel, and optionally the another inspection channel, which binary defect representation contains the shape and size of the respective defect and may be used to determine the shape and size accordingly.

The used second NN algorithm represents an assignment based on a neural network. The second NN algorithm uses the neural network to assign a binary representation of the defect to all image sections of all inspection channels associated with the respective defect. In one embodiment, the second neural network forms a convolutional neural network (Convolutional Neural Network, CNN) through which a binary image is generated from the image sections, in which the pixels belonging to the defect appear in a first color (e.g., white) and pixels not belonging to the defect appear in a second color different from the first color (e.g., black). Using the second NN algorithm, a probability is determined for each pixel of the image sections of all inspection channels of the respective defect as to whether this pixel belongs to the defect or not. For pixels for which the probability that the pixel belongs to the defect is greater than or equal to 0.5, a white color (or a 1) is assigned, for example, and for all other pixels a black color (or a 0) is assigned. For example, a neural network based on the U-Net architecture is used for this purpose, which has proven to be very suitable for such image-to-image transformation problems. The UNet model consists of two main parts: the so-called “encoder” and the “decoder.” The encoder consists of several convolutional layer blocks, which step by step compress the image sections into a compact representation (feature map). The decoder is a symmetrical structure to the encoder. It consists of a sequence of Up Convolutional Layer blocks, which cause the compressed Feature Map to return to the original resolution of the input image. In addition, there is a connection between the encoder and decoder, often referred to as a “skip connection.” At the end of the UNet model, a softmax layer is used to calculate the probability of whether the respective pixel belongs to the respective defect type.

In one embodiment, the inspection channel-specific NN algorithm is trained using ground truth images of defects that have been previously assessed by experts with regard to the various defect types and assigned to a specific defect type. With regard to the second NN algorithm, for example, the defects are outlined by experts with a polygon in training image sections. From this, a mask is generated which comprises pixels within the polygon that belong to the defect and therefore have a value of 1, for example, and pixels outside the polygon that have a value of 0, for example. A plurality of such masks is used for training the NN algorithm, for example in the manner described above with regard to ResNet18.

In one embodiment, as described above or below, the training of the first NN algorithm is performed using an adaptive learning rate optimizer and/or the training of the second NN algorithm is performed using a Dice coefficient loss function.

The above object is further solved by a device for inspecting a coating on the surface of an object, wherein the device comprises an image recording unit, e.g. a camera, and a data processing unit, wherein the image recording unit and, optionally, the data processing unit is/are configured to generate a plurality of first images of the object surface in relation to a first optical inspection channel, a plurality of second images of the object surface in relation to a second optical inspection channel, and optionally a plurality of another images of the object surface in relation to at least one another optical inspection channel, wherein the data processing unit is configured such that the plurality of images of each inspection channel is automatically analyzed with regard to the presence of a defect and that the following steps are performed for each inspection channel and each detected defect:
Assigning those image sections of the plurality of images of the respective inspection channel that contain the location of the respective detected defect,
Determining an inspection channel-specific defect type and an associated inspection channel-specific assessment parameter of the determined inspection channel-specific defect type for those inspection channels to which at least one image section of the location of the detected defect may be assigned, wherein the determination is made by means of a first NN algorithm trained for the respective inspection channel on the basis of the image sections of the respective inspection channel assigned to the respective defect,
   wherein the data processing unit is configured such that subsequently, for each detected defect of the object surface, a defect type is selected by means of soft voting from the inspection channel-specific defect types determined for the respective defect and the associated inspection channel-specific assessment parameters, and that for each detected defect on the object surface, the defect type so selected is output at an interface of the data processing unit.

The above device has the advantages described above in relation to the method and corresponding embodiments. Reference is therefore made to the above and below explanations of the method and device in relation to the device.

In one embodiment of the device, the data processing unit is configured to such that in addition, the location of each detected defect on the object surface is determined in a predetermined coordinate system.

In one embodiment of the device, the data processing unit is configured such that the images of an inspection channel are generated on the basis of a plurality of recordings taken by the image recording unit of different sections of the object surface when the object surface is illuminated by an illumination device with a predetermined inspection channel-specific pattern.

In one embodiment of the device, the data processing unit is configured such that the images of an inspection channel are generated on the basis of a first plurality of recordings made by the image recording unit of different sections of the object surface when the object surface is illuminated with a first predetermined pattern and of at least a second plurality of recordings made by the image recording unit of different sections of the object surface when the object surface is illuminated with at least a second predetermined pattern, as well as of the pixel-wise calculation of a sum image, a contrast image, a phase image, or a curvature image from the recordings of the section at the same location.

In one embodiment of the device, the data processing unit is configured such that, for a specific defect, binary defect representation is determined by means of a second NN algorithm from the image sections assigned to the respective defect of at least one predetermined inspection channel of the first inspection channel, the second inspection channel, and, optionally, the another inspection channel, which binary defect representation contains the shape and size of the respective defect.

In one embodiment, analogous to the above procedure, ground truth image sections are used, for which a binary representation is provided as a corresponding annotation. During training, the annotated images are provided first. The data is divided into training, validation, and test sets, for example, to train the second NN algorithm (e.g., UNet model) and to evaluate its performance. The UNet model is then configured and created, for example, to carry out the training. The model consists of an encoder and decoder architecture with a Softmax output at the end, which calculates the probability of assigning the respective pixel to the defect. For example, the Dice Coefficient Loss is used as a loss function to minimize the difference between the predicted segmentation and the actual segmentation of the training data. Then, the model is trained with the training sets. For this, the model is fed with the images and the corresponding annotation data and adjusted to improve performance. Training may be performed over several epochs, wherein the model weights are updated after each epoch. Subsequently, a validation curve is created, which monitors the loss function on the training and validation sets in relation to the respective epoch, and if the validation loss value decreases, the trained weights are saved in relation to this epoch. Herein, the validation sets are image section data that were not included in the training sets. The same applies to the test sets. At the end of training, the model is evaluated with respect to a test set in order to assess its performance with respect to new data.

Another advantages, features, and possible applications of the present invention are also apparent from the following description of embodiments and the drawings. All features described and/or illustrated, either individually or in any combination, form the subject matter of the invention, even independently of their summary in the claims or their references.

### SCHEMATICALLY SHOW

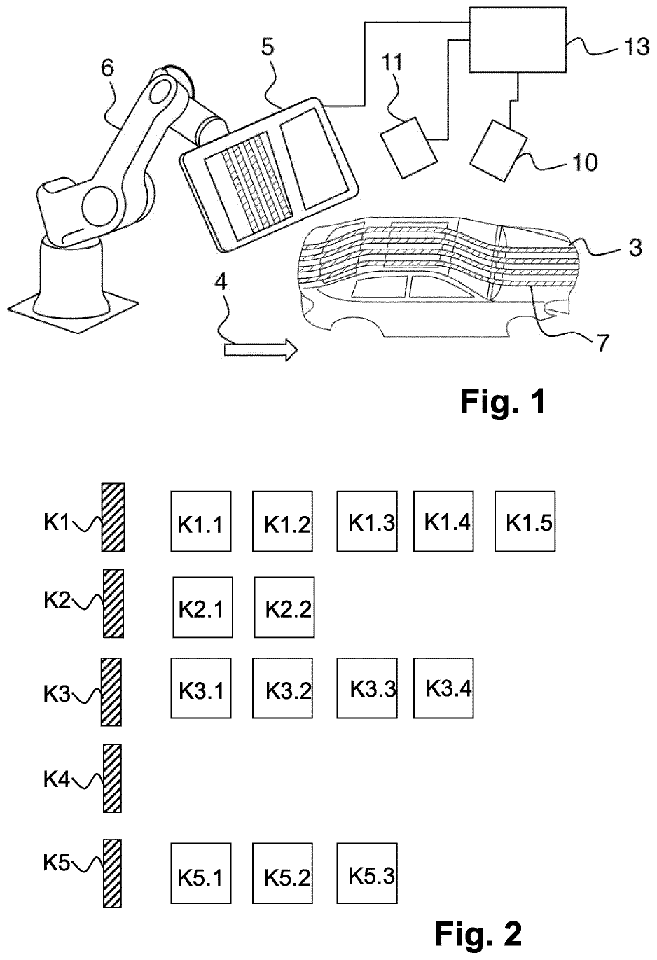

FIG. 1 a side view of an embodiment of the device according to the invention,

FIG. 2 an exemplary presentation of the inspection channels and images assigned to each inspection channel, and

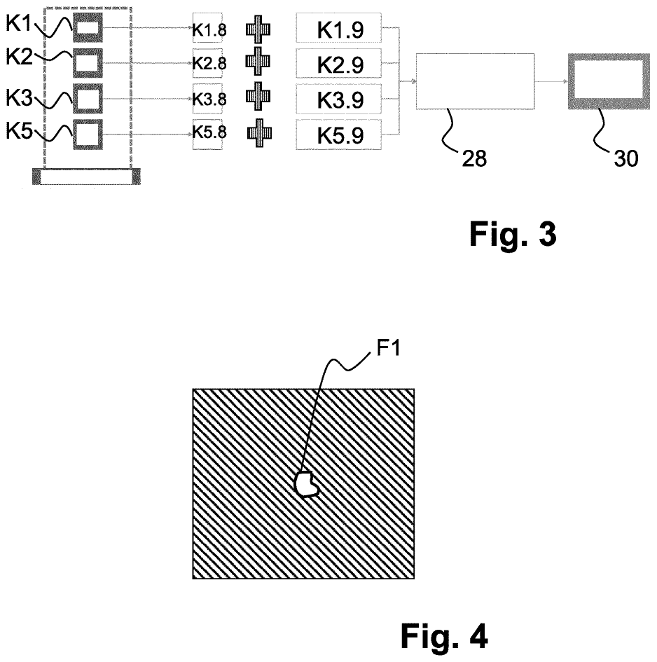

FIG. 3 a flowchart of a proportion of the method according to the invention.

FIG. 1 shows an embodiment of a device according to the invention, which is used to inspect an object being a car chassis 3 provided with a paint coating. The chassis 3 is moved past the device on a conveyor belt (not shown) namely in the feed direction, which is illustrated in FIG. 1 by arrow 4.

The inspection device comprises an illumination unit 5 attached to a robot arm 6, wherein the robot arm 6 enables precise adjustment of the position of the illumination unit relative to the chassis 3 or to other objects to be inspected.

The illumination unit 5 comprises a plurality of LEDs that generate an illumination pattern by switching these LEDs on and off. For example, as shown in FIG. 1, a striped pattern 7 may be generated that extends parallel to the feed direction on the surface of the chassis 3. Other patterns, e.g., offset striped patterns parallel to the feed direction, striped patterns transverse to the feed direction, or full illumination (all LEDs of the illumination unit 5 are switched on), may also be realized. The light reflected from the surface of the chassis 3 is recorded from different viewing angles by matrix cameras 10, 11, wherein a plurality of recordings of the chassis 3 are generated for all of the lighting configurations specified below and during the relative movement of the chassis 3 and cameras 10, 11, digitized, and transmitted to the data processing unit (computer) 13. Each matrix camera 10, 11 generates recordings of different sections of the chassis. The data processing unit 13 is electrically connected to the matrix cameras 10, 11. It also controls the times at which the matrix cameras 10, 11 are read out. Furthermore, the data processing unit 13 is connected to the illumination unit 5 to control the illumination patterns produced by the latter. Naturally, the readout of the matrix cameras 10, 11 and the setting of the respective illumination pattern are synchronized in time.

An example of illumination using the illumination unit 5 and the corresponding generation of recordings using the matrix cameras 10, 11 includes the following configurations:
Illumination 1: all LEDs of the illumination unit 5 switched on,
Illumination 2: illumination pattern includes rectangular stripes transverse to the feed direction, Illumination 3: illumination pattern includes rectangular stripes parallel to the feed direction (see illumination pattern 7),
Illumination 4: illumination pattern as in illumination 3, but offset by ¼ period, Illumination 5: as in illumination 2,
Illumination 6: illumination pattern as in illumination 3, but offset by ½ period, Illumination 7: illumination pattern as in illumination 3, but offset by ¾ period, Illumination 8: illumination pattern includes sine strips parallel to the feed direction, Illumination 9: illumination pattern as in illumination 8, but offset by ½ period.

The illumination configurations 1 to 9 are set one after the other, and the recordings are generated using the matrix cameras 10, 11. The chassis 3 moves/rests during the illumination and the generation of the recordings.

The plurality of recordings for the various sections of the chassis 3 are transmitted to the data processing unit 13. There, images of a plurality of inspection channels are generated from these recordings. The following images of the inspection channels (abbreviated: K) are generated in this embodiment for further inspection:
K1: Recordings of illumination 1, wherein the respective low-pass filtered image is subtracted from all recordings,
K2: Recordings of illumination 2, wherein only the signals along the stripes are included for processing,
K3: Recordings of illumination 3, wherein only the signals along the stripes are included for processing, K4: Recordings of illumination 4, wherein only the signals along the stripes are included for processing,
K5: Recordings of illumination 5, wherein only the signals along the stripes are included for processing,
K6: Recordings of illumination 6, wherein only the signals along the stripes are included for processing,
K7: Recordings of illumination 7, wherein only the signals along the stripes are included in the processing,
K8: Recordings of illumination 2, wherein only the signals of the transition zone between two stripes are included in the processing,
K9: Recordings of illumination 3, wherein only the signals of the transition zone between two stripes are included in the processing,
K10: Recordings of illumination 4, wherein only the signals of the transition zone between two stripes are included in the processing,
K11: Recordings of illumination 5, wherein only the signals of the transition zone between two stripes are included in the processing,
K12: Recordings of illumination 6, wherein only the signals of the transition zone between two stripes are included in the processing,
K13: Recordings of illumination 7, wherein only the signals of the transition zone between two stripes are included in the processing,
K14: Sum images from the recordings of illuminations 8 and 9 by means of the equation (1) shown above.

All images are subsequently examined to determine whether they contain defects. Defects are detected in different ways for the various inspection channels: For K1, for example, the difference already calculated with respect to the low-pass filtered image is binarized using an adaptive tile-based threshold operation, and from this it is determined whether defects are present in the respective image and, if so, where they are located. For all other inspection channels, an overlay image is first calculated that contains information about where the dark stripes, the light stripes, and the transition zones between the dark and light stripes are located. Gradients are then calculated in relation to the captured images. The overlay images (masks) are used to correct the gradient images (e.g., by addition). For inspection channels K2 to K7, the correction is performed in the transition zone between the stripes; for inspection channels K8 to K13, the correction is performed in the area of the light or dark stripes themselves. After correcting, threshold-based binarization is also performed and the binarized image is used to check whether a defect exists in the respective image (e.g., by considering the size of the areas highlighted in the binarized image).

If a defect is detected, the local position of the defect is determined and the image sections that also contain the defect are identified for all channels K1 to K14. These may have a size of 80 pixels×80 pixels, for example. This determination is based on the local assignment of the image sections to the position of the defect. The location of the defect and the determination of the image sections associated with the location are carried out, for example, in the coordinate system of the object.

The result is a series of channels for which at least one image section of the detected defect may be determined. FIG. 2 illustrates this for channels K1 to K5. The further explanation of the method applies accordingly to the other channels K6 to K14.

FIG. 2 shows channels K1 to K5, wherein five image sections K1.1 to K1.5 containing the detected defect may be assigned to channel K1. Accordingly, channel K2 contains two image sections K2.1 and K2.2, channel K3 contains four image sections K3.1 to K3.4, channel K4 contains no image section, and channel K5 contains three image sections K5.1 to K5.3.

Since the fourth channel does not contain any image sections that can be assigned to the detected defect, it is not taken into account in the further procedure shown in FIG. 3.

For each inspection channel to which image sections can be assigned in relation to the detected defect (in this case K1, K2, K3, and K5), a defect type and an assessment parameter are now determined using a first NN algorithm trained for the respective channel in the form of a ResNet (e.g., ResNet18 as described above). For channel K1, the defect type is K1.8 and the assessment parameter is K1.9. Similarly, for channel K2, the defect type is K2.8 and the assessment parameter is K2.9; for channel K3, the defect type is K3.8 and the assessment parameter is K3.9; and for channel K5, the defect type is K5.8 and the assessment parameter is K5.9. E.g., the values contained in the following table may be determined for two examples of values, wherein three defect types A, B, and C (e.g., inclusion, crater, or protrusion (dent)) are fundamentally possible. In both examples, defect type A is selected for this defect and output at the interface of the data processing unit.

| | | | Average of | |
|---|---|---|---|---|
| | | | assessment | Soft-Voting |
| | Example 1 | Frequency | parameter | (4 channels) |
| K1.8 | Defect type A | | | |
| K1.9 | 0.9 | | | |
| K2.8 | Defect type A | | | |
| K2.9 | 0.85 | | | |
| K3.8 | Defect type A | | | |
| K3.9 | 0.34 | | | |
| K5.8 | Defect type B | | | |
| K5.9 | 0.5 | | | |
| Soft- Voting | Defect type A | 3 | 0.69666667 | 3/4*0.69666667/4 = |
| (4 channels) | | | | 0.130625 |
| | Defect type B | 1 | 0.5 | 1/4 * 0.5/4 = |
| | | | | 0.03125 |
| | Defect type C | 0 | | 0 |
| | | | Average of | |
| | | | assessment | Soft-Voting |
| | Example 2 | Frequency | parameter | (4 channels) |
| K1.8 | Defect type A | | | |
| K1.9 | 0.9 | | | |
| K2.8 | Defect type C | | | |
| K2.9 | 0.34 | | | |
| K3.8 | Defect type B | | | |
| K3.9 | 0.34 | | | |
| K5.8 | Defect type C | | | |
| K5.9 | 0.34 | | | |
| Soft-Voting | | | | |
| (4 channels) | | | | |
| Frequency | Defect type A | 1 | 0.9 | 1/4 * 0.9/4 = 0.056 |
| | Defect type B | 1 | 0.34 | 1/4 * 0.34/4 = |
| | | | | 0.02125 |
| | Defect type C | 2 | 0.34 | 2/4 * 0.34/4 = |
| | | | | 0.0425 |

The inspection channel-specific defect types K1.8, K2.8, K3.8, and K5.8 with the associated inspection channel-specific assessment parameters K1.9, K2.9, K3.9, and K5.9 are then fed into a soft voting module 28 of the method. The soft voting performed by this module applies the method described above (the average value is determined as the arithmetic mean) and, in both examples, defect type A is selected from the inspection channel-specific defect types K1.8, K2.8, K3.8, and K5.8, since the calculated value of the soft voting is greatest for this defect type (see tables above). The defect type determined in this way (defect type A) is subsequently made available for the respective defect at the interface of the data processing unit 13 (see step 30 in FIG. 3).

If another defect is detected, the steps of channel-wise assignment of the image sections belonging to the defect and the steps subsequently described above are repeated.

Furthermore, the location (position) of the respective defect may be converted from the coordinate system of the inspection device to the position in the coordinate system of the chassis 3 by means of coordinate transformation.

By means of a second NN algorithm, a binary defect representation can be determined from all image sections K1.1 to K5.3 of all channels K1 to K5 that have been assigned to the defect, as shown in FIG. 4. There, the pixels in area F1 are white-they contain the shape and size of the respective defect. The areas around area F1 are black (shown here as stripes). The striped areas are the areas that are different from the defect.

The shape and size of the defect may be easily calculated based on the determined area F1.

The binary defect representation may be determined analogously for all detected defects by applying the second NN algorithm.

The location of all detected defects and their binary defect representation may also be made available at the interface of the data processing unit 13.

1: A method for inspecting a coating on a surface of an object, the method comprising:
generating a plurality of first images of the object surface with respect to a first optical inspection channel, a plurality of second images of the object surface with respect to a second optical inspection channel, and, optionally, a plurality of another images of the object surface with respect to at least one another optical inspection channel,
automatically analyzing the plurality of images of each inspection channel is with regard to the presence of a defect,
the method further comprising the following steps being performed for each inspection channel and each detected defect:
assigning image sections of the plurality of images of the respective inspection channel that contain the location of the respective detected defect,
determining an inspection channel-specific defect type and an associated inspection channel-specific assessment parameter of the determined inspection channel-specific defect type for those inspection channels to which at least one image section of the location of the detected defect could be assigned, wherein the determination is made by a first NN algorithm trained for the respective inspection channel on the basis of the image sections of the respective inspection channel assigned to the respective defect,
subsequently, for each detected defect of the object surface, selecting a defect type by soft voting from the inspection channel-specific defect types of the respective inspection channels determined for the respective defect and the associated inspection channel-specific assessment parameters, and
outputting the defect type so selected for each detected defect of the object surface at an interface of a data processing device.

2: The method according to claim 1, wherein, additionally, the location of each detected defect on the object surface is determined in a predetermined coordinate system.

3: The method according to claim 1, wherein the images of an inspection channel are generated on the basis of a plurality of recordings of different sections of the object surface when the object surface is illuminated with a predetermined inspection channel-specific pattern.

4: The method according to claim 1, wherein the images of an inspection channel are generated on the basis of a first plurality of recordings of different sections of the object surface when the object surface is illuminated with a first predetermined pattern and of at least a second plurality of recordings of different sections of the object surface when the object surface is illuminated with at least a second predetermined pattern, as well as of pixelwise calculation of a sum image, a contrast image, a phase image, or a curvature image from the recordings of the section at the same location.

5: The method according to claim 1, wherein, for a specific defect, a binary defect representation is determined by a second NN algorithm from the image sections assigned to the respective defect of at least one predetermined inspection channel of the first inspection channel, the second inspection channel, and optionally the another inspection channel, which binary defect representation contains the shape and size of the respective defect.

6: The method according to claim 1, wherein the training of the first NN algorithm is performed by an adaptive learning rate optimizer and/or the training of the second NN algorithm is performed by a Dice coefficient loss function.

7: A device for inspecting a coating on the surface of an object, the device comprising:
an image recording unit and
a data processing unit,
wherein the image recording unit and, optionally, the data processing unit is/are configured to generate a plurality of first images of the object surface in relation to a first optical inspection channel, a plurality of second images of the object surface in relation to a second optical inspection channel, and optionally a plurality of another images of the object surface in relation to at least one another optical inspection channel,
wherein the data processing unit is configured such that the plurality of images of each inspection channel is automatically analyzed with regard to the presence of a defect and that the following steps are performed for each inspection channel and each detected defect:
assigning image sections of the plurality of images of the respective inspection channel that contain the location of the respective detected defect,
determining an inspection channel-specific defect type and an associated inspection channel-specific assessment parameter of the determined inspection channel-specific defect type for those inspection channels to which at least one image section of the location of the detected defect may be assigned, wherein the determination is made by a first NN algorithm trained for the respective inspection channel on the basis of the image sections of the respective inspection channel assigned to the respective defect,
wherein the data processing unit is configured such that subsequently, for each detected defect of the object surface, a defect type is selected by soft voting from the inspection channel-specific defect types determined for the respective defect and the associated inspection channel-specific assessment parameters, and
wherein, for each detected defect on the object surface, the defect type so selected is output at an interface of the data processing unit.

8: The device according to claim 7, wherein the data processing unit is configured such that, in addition, the location of each detected defect on the object surface is determined in a predetermined coordinate system.

9: The device according to claim 7, wherein the data processing unit is configured such that the images of an inspection channel are generated on the basis of a plurality of recordings taken by the image recording unit of different sections of the object surface when the object surface is illuminated by an illumination device with a predetermined inspection channel-specific pattern.

10: The device according to claim 7, wherein the data processing unit is configured such that the images of an inspection channel are generated on the basis of a first plurality of recordings made by the image recording unit of different sections of the object surface when the object surface is illuminated with a first predetermined pattern and of at least a second plurality of recordings made by the image recording unit of different sections of the object surface when the object surface is illuminated with at least a second predetermined pattern, as well as of the pixel-wise calculation of a sum image, a contrast image, a phase image, or a curvature image from the recordings of the section at the same location.

11: The device according to claim 7, wherein the data processing unit is configured such that, for a specific defect, a binary defect representation is determined by a second NN algorithm from the image sections assigned to the respective defect of at least one predetermined inspection channel of the first inspection channel, the second inspection channel, and optionally the further inspection channel, which binary defect representation contains the shape and size of the respective defect.

12: The device according to claim 7, wherein the training of the first NN algorithm is performed by an adaptive learning rate optimizer and/or the training of the second NN algorithm is performed by a Dice coefficient loss function.
